(19) United States
(12) Patent Application Publication
(10) Pub. No.: US 2020/0387855 A1
(43) Pub. Date: Dec. 10, 2020

(54) SALES MANAGEMENT SYSTEM AND SALES MANAGEMENT METHOD

(71) Applicant: NIPPON EXPRESS CO., LTD., Tokyo (JP)

(72) Inventors: Mizuho YUI, Tokyo (JP); Nobuaki KANAZAWA, Tokyo (JP)

(21) Appl. No.: 16/497,936

(22) PCT Filed: Mar. 28, 2018
(86) PCT No.: PCT/JP2018/012923

§ 371 Date: Sep. 26, 2019

(30) Foreign Application Priority Data
Mar. 31, 2017 (JP) 2017-070761

(51) Int. Cl. G06Q 10/08; G06Q 30/06

(52) U.S. Cl. CPC G06Q 10/087; G06Q 30/06; G06Q 10/0831

(57) ABSTRACT

The purpose of the present invention is to implement management in a more expedient manner than heretofore in a commercial transaction involving import/export. Provided is a sales management system which, on receiving a request for salability decision from a first country for each product which has been assigned a first management information: decides the salability for a second country; responds with a second management information for the salable products to the requestor in the first country; stores the first management information in linkage with the second management information; and on the basis of the linked first management information and second management information, implements management relating to the sale of the products in the second country, involving export of a single consolidated shipment of the products, which are sold by different manufacturers and have different owners, from the first country to the second country.

### TECHNICAL FIELD

The present invention relates to a sales management system and a sales management method for implementing sales-related management.

### BACKGROUND ART

International commercial transactions involving the import/export of products are generally carried out on the back of the development of global networks such as the internet and the maintenance of distribution networks. Technology enabling international commercial transactions of this kind to be performed easily is disclosed in Patent Document 1, for example. Specifically, the technology disclosed in Patent Document 1 is an internet sales system which performs commercial transactions between a user terminal and a sales system via the internet, wherein the sales system performs a settlement substitution service using settlement information representing a currency from the user terminal.

Patent Document 1: Japanese Unexamined Patent Application, Publication No. 2014-194693

### DISCLOSURE OF THE INVENTION

### Problems to be Solved by the Invention

By utilizing the technology disclosed in the foregoing Patent Document 1 and so forth, the settlement of international commercial transactions involving the import/export of products, for example, can be easily performed. Incidentally, with a general technology such as the technology disclosed in Patent Document 1, when managing products, products are managed by allocating one common management information item both domestically and overseas. For example, in the example of the technology disclosed in Patent Document 1, individual products are managed by means of one management information item such as “product name,” as disclosed in FIG. 3 of Patent Document 1. However, supposing that domestic product manufacturers and exporters and overseas product sellers are only able to manage products by means of the same management information, for example, cases where management is complex are also conceivable. The present invention relates to a sales management system and sales management method which enable management to be implemented in a more expedient manner than heretofore in a commercial transaction involving an export.

### Means for Solving the Problems

According to a first aspect of the present invention, a sales management system (sales management system 100, described subsequently, for example) includes domestic communication means (domestic communication unit 23, described subsequently, for example) which receives a product sales request from a manufacturer terminal (manufacturer terminal 10, described subsequently, for example); management means (management unit 21, described subsequently, for example) which, on receiving the product sales request, assigns first management information to each of the products; overseas communication means (overseas communication unit 24, described subsequently, for example) which issues a request for a salability decision for the products to an overseas business device and receives, in response, second management information assigned to salable products; and management information storage means (management information storage unit 22, described subsequently, for example) which stores, for each of the products, the first management information and second management information in linkage with each other, wherein, on the basis of the linked first management information and second management information, the management means implements management relating to the sale of the products overseas, involving an export of the products overseas from a domestic country.

According to a second aspect of the present invention, a sales management method executed by a computer (a device in the sales management system 100 described subsequently, for example) is provided, the sales management method including a domestic communication step of receiving a product sales request from a manufacturer terminal; a management step of, on receiving the product sales request, assigning first management information to each of the products; an overseas communication step of issuing a request for a salability decision for the products to an overseas business device and receiving, in response, second management information assigned to salable products; and a management information storage step of storing, for each of the products, the first management information and second management information in linkage with each other, wherein, on the basis of the linked first management information and second management information, management relating to the sale of the products overseas, involving an export of the products overseas from a domestic country, is implemented.

### Effects of the Invention

According to the present invention, management can be implemented in a more expedient manner than heretofore in a commercial transaction involving an export.

### BRIEF DESCRIPTION OF THE DRAWINGS

FIG. 1 is an image diagram illustrating an overview of an international commercial transaction targeted for management according to an embodiment of the present invention, and movements of products in the commercial transaction.

FIG. 2 is a diagram representing an overall basic configuration of the embodiment of the present invention.

FIG. 3 is a block diagram illustrating functional blocks included in a first business device and functional blocks included in a second business device, according to the embodiment of the present invention.

FIG. 4 is a flowchart (1 of 2) illustrating operations for sales proposals, exports of goods for sale, and transportation cost adjustments, according to the embodiment of the present invention.

FIG. 5 is a flowchart (2 of 2) illustrating operations for sales proposals, exports of goods for sale, and transportation cost adjustments, according to the embodiment of the present invention.

FIG. 6 is a flowchart illustrating operations for cost adjustments, according to the embodiment of the present invention.

FIG. 7 is a flowchart illustrating operations for proceeds adjustments, according to the embodiment of the present invention.

### PREFERRED MODE FOR CARRYING OUT THE INVENTION

An embodiment of the present invention will be described in detail next with reference to the drawings. Here, the present embodiment enables management to be implemented in a more expedient manner than heretofore in a commercial transaction involving an export.

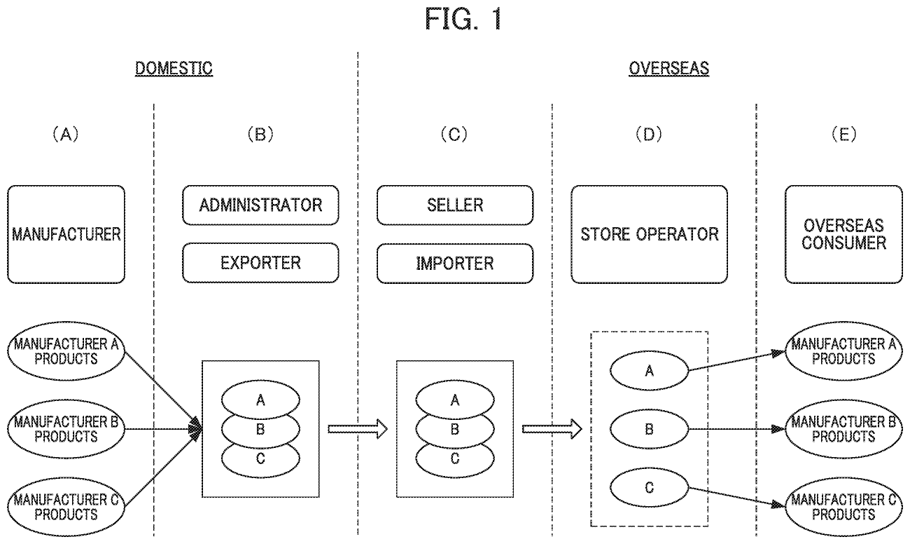

First, an overview of an international commercial transaction targeted for management according to the present embodiment, and movements of products in this commercial transaction will be described with reference to FIG. 1. As illustrated in FIG. 1, a product is sold in a process extending from (A) on the left of the drawing to (E) on the right of the drawing. Here, the subject managing the product in each process is shown at the top of the drawing. In addition, the state of the product is shown at the bottom of the drawing. Note that, in the description hereinbelow, a first country, which is the export source where the manufacturer wishing to sell a product is holding the product, is referred to as the “domestic” country, and a second country which is the export destination of the product is called the “overseas” country.

In the present embodiment, it is assumed that there are a plurality of manufacturers. For example, there are three manufacturers, namely, “manufacturer A,” “manufacturer B,” and “manufacturer C,” and each manufacturer wishes to sell their manufactured goods overseas. Furthermore, as illustrated in (A) of the drawing, at first the products are each managed individually by the manufacturers. Each of these manufacturers wishes to make an overseas consignment sale of their products to an administrator (who is also an exporter). Deposit fees for the consignment sale are advanced to the administrator. In addition, the manufacturers each deliver their own products, which are each managed by the respective companies, to a warehouse designated by the administrator. Further, as illustrated in (B) of the drawing, the products of each manufacturer are consolidated by manufacturer.

Here, because this is a consignment sale, the products remain the property of the manufacturer until the products are actually sold overseas. Further, through a process that will be described subsequently, the manufacturer receives the proceeds via the administrator after the product has been sold. Accordingly, if the manufacturers each deliver the products to a warehouse designated by the administrator, the manufacturers are able to make sales without subsequently implementing product management and procedures and so forth. Each manufacturer is therefore able to make sales overseas without requiring complex procedures or know-how, or similar.

The administrator implements export-related business tasks and management, including procedures for transporting the products delivered by each manufacturer and procedures for exporting the products delivered by each manufacturer as a single consolidated shipment of products. Accordingly, as illustrated in (C) of the drawing, the products of each manufacturer that have been consolidated as a single shipment of products are exported overseas and move to overseas sellers (who are also importers).

The overseas sellers import the products of each manufacturer that have been exported as a single consolidated shipment of products, and perform procedures for actually selling the products overseas at stores run by store operators who are overseas sales channels. Sellers also implement product inventory management.

By performing bulk trading and bulk import/export in cooperation with domestic administrators and overseas sellers, overseas sales can be achieved at low cost. Moreover, because of deposit sales, there is no need for domestic administrators and overseas sellers to bear the risk of procuring stock. As a result, consignment fees can also be kept low.

A store operator is, for example, a business that runs a mall-type electronic commerce (EC) site or a business that runs a real store. The store operator sells the products of each manufacturer to overseas consumers. Accordingly, the products of each manufacturer reach overseas consumers from warehouses, stores, and so forth which are managed by sellers or store operators, as illustrated in (C), (D), and (E) in the drawing.

The proceeds from selling products (sales) are paid to the manufacturer via the seller and administrator after predetermined fees and the like have been deducted by the store operator. The store operator is able to enter into a collective contract for the products of each manufacturer with the seller acting as the source of sales. The store operator is therefore able to make sales without performing complex procedures and so forth associated with imported goods from a plurality of overseas manufacturers.

As described hereinabove, commercial transactions are profitable for each party involved. The present embodiment enables such commercial transactions to be realized smoothly by implementing management of the commercial transactions.

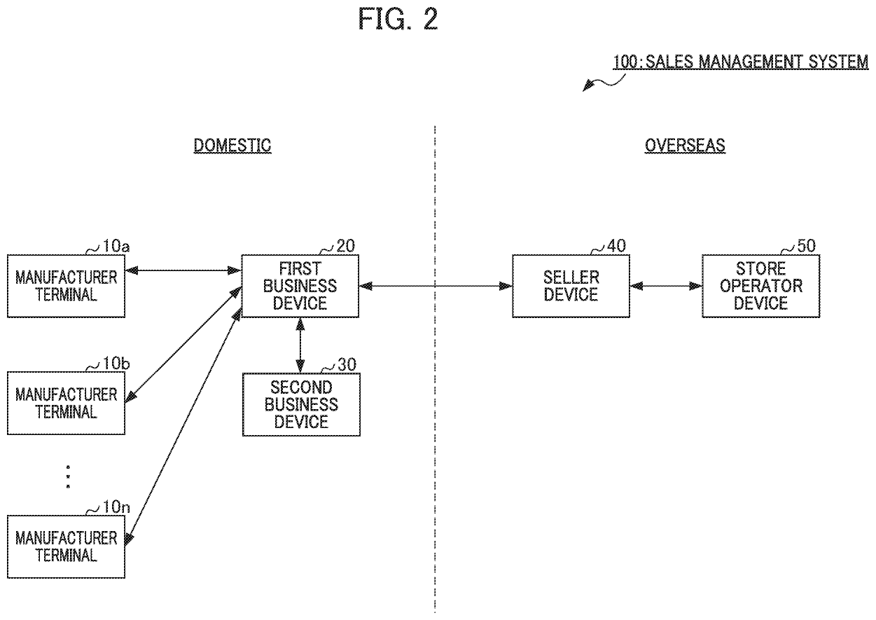

The configurations and operations of the present embodiment for realizing such commercial transactions smoothly will be described next with reference to the drawings. First, an overall configuration of the present embodiment will be described with reference to FIG. 2. As illustrated in FIG. 2, a sales management system 1, which is the present embodiment, is configured comprising a plurality of manufacturer terminals 10, a first business terminal 20, a second business terminal 30, a seller device 40, and a store operator device 50. Each of these terminals and devices are communicably coupled to one another. Such communication is not particularly limited to a communications standard and can be realized through the combined use of a network such as the internet or a public telephone network and a LAN (Local Area Network), omitted from FIG. 2, and by using either wired communication or wireless communication, or a combination of both, for example. Furthermore, in the drawing, although manufacturer terminals 10a to 10n (where n is any natural number) are illustrated and one of each device is illustrated, there are no restrictions on the manufacturer terminals 10 or on the quantity of each device, and coupling therebetween need not be one-to-one coupling and could instead be one-to-many coupling or many-to-many coupling.

Here, the manufacturer terminals 10 are terminals that are respectively used by the plurality of manufacturers in FIG. 1. In addition, the first business terminal 20 and second business terminal 30 are devices that are used by the administrator (who is also an exporter) in FIG. 1. Further, the seller device 40 is a device that is used by the seller (who is also an importer) in FIG. 1. Moreover, the store operator device 50 is a device that is used by the store operator in FIG. 1. Note that, the overseas consumer in FIG. 1 may also use an electronic device such as a personal computer to perform an electronic transaction on a website, but the electronic device itself which is a personal computer or the like does not constitute the gist of the present embodiment, and therefore an illustration of the electronic device is omitted from FIG. 2.

The manufacturer terminals 10a to 10n are terminals that are respectively used by the manufacturers. The manufacturer terminals 10a to 10n communicate exclusively with the first business terminal 20. The manufacturers use the manufacturer terminals 10 to transmit product sales requests and receive sales codes and usage fees and so forth, which will be described subsequently.

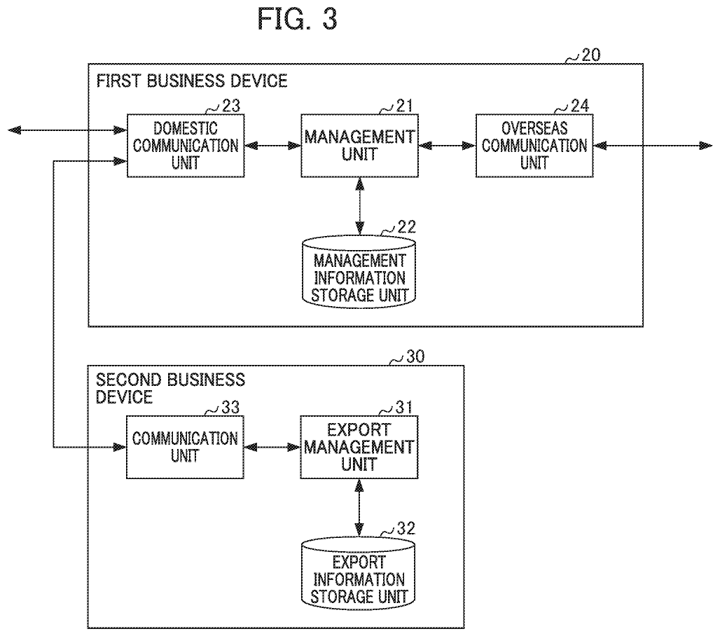

The first business terminal 20 and second business terminal 30 are devices for managing the foregoing commercial transactions with reference to FIG. 1. Specific functional blocks of the first business terminal 20 and second business terminal 30 will be described subsequently with reference to FIG. 3.

The seller device 40 is a device that performs processing for overseas imports and sales. The seller device 40 communicates exclusively with the first business terminal 20 and the store operator device 50.

The store operator device 50 is a device that performs processing for overseas sales. The store operator device 50 communicates exclusively with the seller device 40.

As described hereinabove, each terminal and device can be realized by a personal computer or server device. To describe this in more detail, each of these terminals and devices includes an arithmetic processing unit such as a CPU (Central Processing Unit). In addition, each of these terminals and devices includes an auxiliary storage unit such as an HDD (Hard Disk Drive), which stores various control programs, and a main storage device such as a RAM (Random Access Memory) for storing data which is temporarily required when the arithmetic processing unit executes programs.

In each of these terminals and devices, the arithmetic processing unit reads an application and an OS from the auxiliary storage unit, and while opening, in the main storage device, the application and OS thus read, performs arithmetic processing on the basis of the application and OS. In addition, the arithmetic processing unit controls various hardware of each of these terminals and devices on the basis of the arithmetic processing results. Consequently, processing by functional blocks, described subsequently, and by each of these terminals and devices is realized. That is, the present embodiment can be realized by way of cooperation between hardware and software.

The functional blocks which the foregoing first business terminal 20 and second business terminal 30 comprise will be described next with reference to FIG. 3. As illustrated in FIG. 3, the first business terminal 20 is configured comprising a management unit 21, a management information storage unit 22, a domestic communication unit 23, and an overseas communication unit 24. In addition, the second business terminal 30 is configured comprising an export management unit 31, an export information storage unit 32, and a communication unit 33. Each of these functional blocks is realized as a result of cooperation between hardware such as an arithmetic processing unit and a storage device as described earlier, or a communication module, and software.

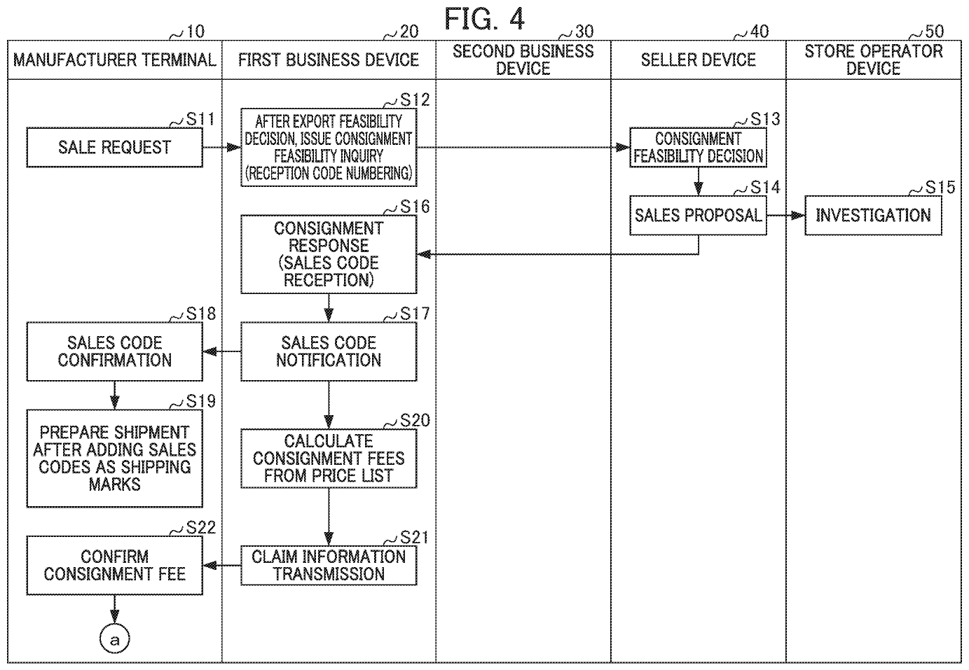

The management unit 21 is a management unit for realizing each of the processes described subsequently with reference to FIGS. 4 to 7. The management unit 21 performs communication by using the domestic communication unit 23 and overseas communication unit 24, described subsequently, and realizes each of the processes by using management information which is information for management purposes stored by the management information storage unit 22, described subsequently.

The management information storage unit 22 is a storage device that stores management information. Here, the management information is managed as a table, for example. The table columns include, for example, items such as manufacturer identification information, reception codes, described subsequently (correspond to the “first management information” of the present invention), sales codes, described subsequently (correspond to the “second management information” of the present invention), product information (the names, types, quantities, weights, and sizes, and so forth, of products, for example), information indicating product states (export in progress, sale in progress, sold, and so forth), and money-related information (deposit fees, amount of proceeds, type of currency used for payments, information indicating whether payment has been made). Furthermore, a row (record) is provided for each manufacturer product, and information of each product is stored in fields that correspond to each of the foregoing items. The management unit 21, for example, performs storage of this information and information updates in the course of each of the processes described subsequently with reference to FIGS. 4 to 7.

The management unit 21 is capable of acquiring each information item by referring to this table. In this case, the management unit 21 uses the reception codes and sales codes as management information for managing products. For example, the management unit 21 uses the reception codes and sales codes as primary keys when referring to and updating product-related information, and as information used for notifications to other devices, and so forth. For this reason, the management unit 21 is configured to be capable of extracting information by using respective reception codes and sales codes as primary keys. For example, the management unit 21 causes the management information storage unit 22 to store, in addition to the foregoing table, a table enabling corresponding sales codes to be extracted using a reception code as a primary key and a table enabling corresponding reception codes to be extracted using a sales code as a primary key. Furthermore, by associating these three tables as a relational database, the management unit 21 is capable of extracting information by using respective reception codes and sales codes as primary keys.

The domestic communication unit 23 is a part for communicating with the manufacturer terminals 10a to 10n, the second business terminal 30, and the like, on the domestic side. Further, the overseas communication unit 24 is a part for communicating with the seller device 40 and the store operator device 50, on the overseas side.

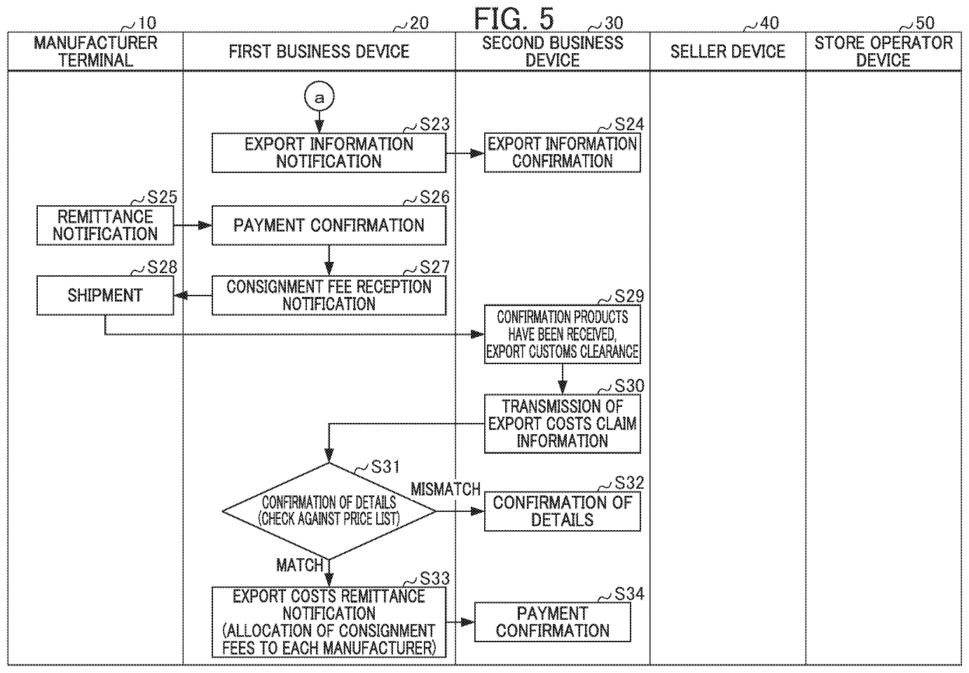

The export management unit 31 is a management unit for realizing export processing, described subsequently, with reference to FIG. 5. The export management unit 31 performs communications by using the communication unit 33, described subsequently, and realizes export processing by using export management information which is information for export management purposes stored by the export information storage unit 32, described subsequently.

The export information storage unit 32 is a storage device that stores export management information. Here, the export management information is managed as a table, for example. The table columns include, for example, items such as manufacturer identification information, reception codes, described subsequently, sales codes, described subsequently, product information (the names, types, quantities, weights, and sizes, and so forth, of products, for example), information indicating product states (domestic transportation in progress, export in progress, and so forth, for example), and export information (information for creating invoices and packing lists for customs clearance, for example). Furthermore, a row (record) is provided for each manufacturer product, and information of each product is stored in fields that correspond to each of the foregoing items. The export management unit 31, for example, performs storage of this information and information updates in the course of each of the processes described subsequently with reference to FIGS. 4 to 7.

The export management unit 31 is capable of acquiring each information item by referring to this table. In this case, like the management unit 21, the export management unit 31 uses the reception codes and sales codes as management information for managing products. For example, the management unit 21 uses the reception codes and sales codes as primary keys when referring to and updating product-related information, and as information used for notifications to other devices, and so forth. For this reason, the export management unit 31 is configured to be capable of extracting information by using respective reception codes and sales codes as primary keys. For example, the export management unit 31 causes the export information storage unit 32 to store, in addition to the foregoing table, a table enabling corresponding sales codes to be extracted using a reception code as a primary key and a table enabling corresponding reception codes to be extracted using a sales code as a primary key. Furthermore, by associating these three tables as a relational database, the export management unit 31 is capable of extracting information by using respective reception codes and sales codes as primary keys.

The export information storage unit 32 is a part for communicating with the second business terminal 30, and the like, on the domestic side.

The configurations and functions of the present embodiment have been described hereinabove. The operation of the present embodiment will be described next with reference to FIGS. 4 to 7. First, the operations for sales proposals, exports of goods for sale, and transportation cost adjustments, according to the embodiment of the present invention, will be described with reference to the flowcharts of FIGS. 4 and 5. Note that, in the description hereinbelow, the manufacturer terminals 10a to 10n are referred to simply as the manufacturer terminals 10, without distinction, by omitting the reference symbols at the end.

In step S11, the manufacturer terminal 10 transmits a product sales request to the first business terminal 20. This sales request includes information for specifying product content. This sales request is issued on the basis of an operation or the like by the manufacturer wishing to sell the product.

In step S12, the first business terminal 20 which has received the sales request decides whether or not the products can be exported as a consolidated shipment of products on the basis of information for specifying product content contained in the sales request. The decision is made, for example, on the basis of a standard stipulating whether exports from the country are prohibited for the product on the basis of the product type, and a standard stipulating whether the product weight and size lie within weight and size ranges for being exported as a single consolidated shipment of products (for storage in a single container, for example). When it has been decided that the product can be exported as a consolidated shipment of products, an inquiry is issued regarding whether or not the export of the product can be consigned to the seller device 40 (imported from the perspective of the seller device 40). Furthermore, the first business terminal 20 performs reception code numbering for the products, assigns the reception codes to the products, and uses the reception codes in subsequent processing.

In step S13, the seller device 40 decides whether or not consignment is feasible. For example, the seller device 40 makes a decision on the basis of a standard stipulating whether the product can be imported into the corresponding country overseas, or similar. When it is decided that consignment is feasible, the seller device 40 issues a sales proposal to the store operator device 50 in step S14. In addition, the seller device 40 issues a reply to the effect that consignment is feasible to the first business terminal 20. This reply contains a sales code. Here, the sales codes can also be numbered and assigned by the seller device 40, but the configuration may be such that when the store operator device 50 uses the numbered and assigned sales codes, the sales codes can be used as is and exchanged with the store operator device 50. That is, the configuration may be such that the store operator device 50 is capable of managing only sales codes which the store operator device 50 itself has numbered and assigned.

In step S15, the store operator device 50 investigates whether a product is to be sold in light of a seller standard. Note that when, provisionally, it has been decided that a product cannot be exported in step S12, it has been decided that the product cannot be consigned in step S13, or it has been decided that the product is not to be sold in step S15, the processing in which a reply to that effect is transmitted from each device to the first business terminal 20 ends.

In step S16, a reply to the effect that consignment is feasible is received from the seller device 40. Here, the sales code contained in the reply is also received. Furthermore, the reception codes numbered in step S12 are stored as management information in linkage with the sales codes.

In step S17, the first business terminal 20 reports the sales code to the manufacturer terminal 10.

In step S18, the manufacturer terminal 10 confirms the sales code. In step S19, the manufacturer terminal 10 outputs the sales code as product management information that is assigned directly or indirectly to product stock when the product is shipped by the manufacturer. This output is performed by printing to paper as shipping marks or by displaying on a display. The manufacturer, who is the user of the manufacturer terminal 10, adds the sales code to the product stock itself or to product packaging material, or the like. For example, the manufacturer adds a paper with a printed sales code. Preparations to ship the product are thus complete.

In step S20, the first business terminal 20 calculates, from a price list, the amount of a deposit fee for a consignment sale which is to be paid by the manufacturer. The price list is a list for calculating a deposit fee according to the product type, quantity, export destination country, and the like, for example. The price list is stored in the management information storage unit 22, for example. Note that the configuration may be such that an insurance premium is added to the consignment fee. More specifically, an insurance premium such as distributed goods insurance, insurance for overseas product liability law, or insurance against infringement of intellectual property rights overseas (for litigation) may also be added. In addition, administrators may elect to use these forms of insurance across the board or insurance can be selected for each manufacturer.

In step S21, the first business terminal 20 transmits claim information on the consignment fee calculated in step S20 to the manufacturer terminal 10 issuing the sales request.

In step S22, the manufacturer terminal 10 confirms the consignment fee. The confirmation result is output using a printing or display device so that the manufacturer who is the user can be notified.

In step S23, the first business terminal 20 generates export information on the basis of the stored management information. Here, export information is information for creating an invoice or a packing list for customs clearance, for example. For example, information for creating an invoice is information such as the name, type and quantity of the product which is to be the cargo, or the address, residence, and name of the administrator serving as the consignor and the seller serving as the consignee. Furthermore, information for creating a packing list is information such as the weight and volume of the product after packing, for example. The first business terminal 20 acquires, by means of a reception code or sales code, information required to generate the export information from management information corresponding to the product, and generates the export information on the basis of the acquired information. The first business terminal 20 then transmits the generated export information to the second business terminal 30.

In step S24, the second business terminal 30 confirms the export information. Here, the export information is information for creating an invoice or a packing list for customs clearance, for example. For example, information for creating an invoice is information such as the name, type and quantity of the product which is to be the cargo, or the address, residence, and name of the administrator serving as the consignor and the seller serving as the consignee. Furthermore, information for creating a packing list is information such as the weight and volume of the product after packing, for example.

In step S25, the manufacturer terminal 10 transmits a notification to the effect that the consignment fee has been remitted to the first business terminal 20. This notification also contains the reception code of the product corresponding to the consignment fee. This transmission is issued on the basis of an operation or the like by the manufacturer who has made the remittance.

In step S26, the first business terminal 20 confirms that the consignment fee has been paid. Thereupon, by referring to the management information stored in the management information storage unit 22 on the basis of the reception code contained in the payment confirmation, the first business terminal 20 is capable of confirming the source of the payment by rapidly and reliably specifying the information of the product corresponding to the consignment fee.

In step S27, the first business terminal 20 transmits the consignment fee receipt notification to the manufacturer terminal 10. This transmission is issued on the basis of an operation or the like by the administrator who has actually confirmed that payment has been made.

In step S28, because the administrator has received the consignment fee, the manufacturer terminal 10 outputs a notification to the effect that shipping can commence. The output is made using a printing or display device or another such device so that the manufacturer who is the user can be notified. Upon referring to the output, the manufacturer ships the product for which shipping has been arranged in describing step S19.

In step S29, the second business terminal 30 confirms that the product has been received at the warehouse designated by the administrator of the second business terminal 30. This confirmation is made on the basis of an operation or the like by the administrator who has actually confirmed the product at the warehouse, for example. After confirming that the product has been received, the export information confirmed in step S24 is output. The output may be printed as an invoice or packing list for customs clearance or may be displayed on a display. The administrator uses the export information that has been output to consolidate the products of each manufacturer (that is, products of different owners) as a single shipment of products (a single container, for example), and export the products with the consignor serving as the administrator. The exported products are received by an overseas seller, that is, imported.

Subsequently, the overseas seller manages the products by means of an overseas warehouse, and asks store operators to sell the products. Note that, depending on the business conditions of the store operators, product management and so forth is sometimes carried out by the store operators.

In step S30, the second business terminal 30 outputs, to the first business terminal 20, claim information for claiming export costs, which are costs generated in export-related procedures or transportation-related costs for export purposes. This claim information contains reception codes of the products corresponding to the export costs. The cost-related claim amounts and details may be input by the administrator or may be calculated by the second business terminal 30 from a prescribed export cost price list.

In step S31, by referring to the management information stored in the management information storage unit 22 on the basis of the reception codes contained in the received claim information received from the second business terminal 30, the first business terminal 20 rapidly and reliably specifies the information of the products that correspond to the export costs. Furthermore, by calculating the export costs on the basis of the product information and export cost price list and checking the export costs against the export costs claimed by means of the claim information, the first business terminal 20 decides whether or not the export costs claimed by means of the claim information are correct.

When both sets of compared export costs do not match (a mismatch in step S31), the first business terminal 20 makes a transmission to the second business terminal 30 to request confirmation of the details. The second business terminal 30 makes an output to the effect that the details must be confirmed. The output is made using a printing or display device or another such device so that the administrator can be notified.

On the other hand, if both sets of compared export costs match (a match in step S31), the processing moves to step S33. In step S33, the first business terminal 20 transmits an export costs remittance notification to the second business terminal 30. This notification is issued on the basis of an operation or the like by the administrator who has actually confirmed the remittance. Note that the export costs are paid from the consignment fees whose payment has been confirmed in step S26. In this case, the consignment fees are allocated to each manufacturer according to the quantity of products for which a sales request has been made.

In step S34, the second business terminal 30 confirms that the export costs have been paid. This confirmation is issued on the basis of an operation or the like by the administrator who has actually confirmed that payment has been made. Note that steps S30 to S34 described hereinabove are steps obtained by assuming a case where the user using the second business terminal 30 as an administrator and the user using the seller device 40 as an administrator are each in another department and another company, and have separate accounts. If there is no need for separate accounts as in a case where the user using the second business terminal 30 as an administrator and the user using the seller device 40 as an administrator are in the same department and so forth, steps S30 to S34 may also be omitted.

As a result of the processing described hereinabove with reference to FIGS. 4 and 5, it is possible to export the products of each manufacturer as a single consolidated shipment of products. Moreover, subsequent management can also be implemented expediently because reception codes and sales codes are linked with each other in the first business terminal 20.

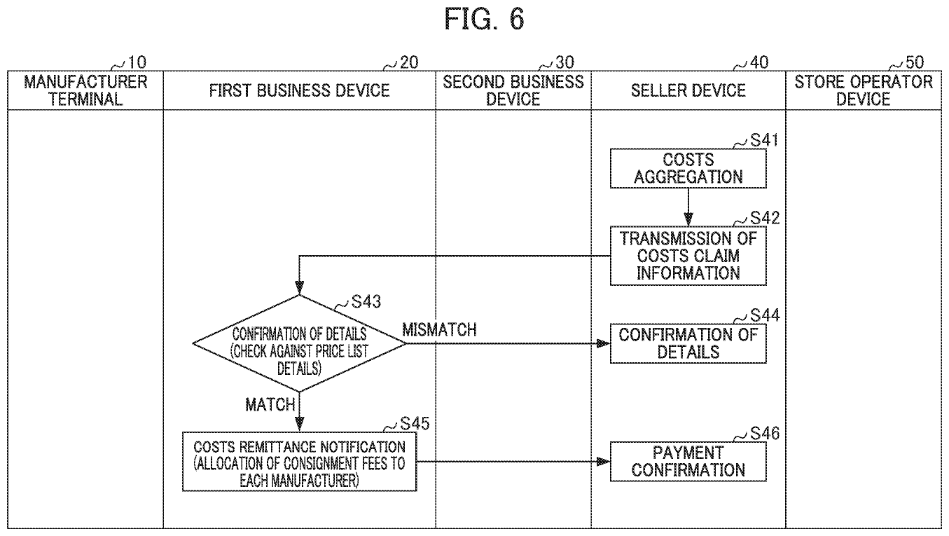

Operations for cost adjustments according to the present embodiment will be described next with reference to the flowchart in FIG. 6. In step S41, the seller device 40 aggregates all costs such as costs generated in export-related procedures, costs for managing received products in a warehouse, and the accompanying transportation-related costs. The foregoing aggregation may be performed on the basis of a seller operation or the like, or may be carried out by means of the seller device 40 using a predetermined cost price list.

In step S42, the seller device 40 transmits, to the first business terminal 20, claim information for claiming costs which are calculated on the basis of the aggregation. This claim information contains the sales codes of the products corresponding to the various costs.

In step S43, by referring to the management information stored in the management information storage unit 22 on the basis of the sales codes contained in the received claim information, the first business terminal 20 rapidly and reliably specifies the information of the products that correspond to the various costs. Furthermore, by calculating costs on the basis of the product information and a costs price list and checking these costs against the costs claimed by means of the claim information, the first business terminal 20 decides whether or not the export costs claimed by means of the claim information are correct.

When both sets of compared costs do not match (a mismatch in step S43), the first business terminal 20 makes a transmission to the seller device 40 to request confirmation of the details. The seller device 40 makes an output to the effect that the details must be confirmed. The output is made using a printing or display device or another such device so that the seller can be notified. On the other hand, if both sets of compared costs match (a match in step S43), the processing moves to step S45. In step S45, the first business terminal 20 transmits a costs remittance notification to the seller device 40. This notification is issued on the basis of an operation or the like by the administrator who has actually confirmed the remittance. Note that the costs are paid from the consignment fees whose payment has been confirmed in step S26. In this case, the consignment fees are allocated to each manufacturer according to the quantity of products for which a sales request has been made.

In step S46, the seller device 40 confirms that the costs have been paid. This confirmation is issued on the basis of an operation or the like by the administrator who has actually confirmed that payment has been made.

As a result of the processing described hereinabove with reference to FIG. 6, it is possible to perform a costs adjustment. In addition, in a case where the seller is an overseas corporation, a cost adjustment can be made using a foreign currency. That is, the first business terminal 20 may be configured to convert the consignment fee received in the domestic currency to the foreign currency of the administrator and to make the cost remittance in the foreign currency. Thus, conversion by the seller may be unnecessary. Centralized management by the administrator including currency conversion is also possible.

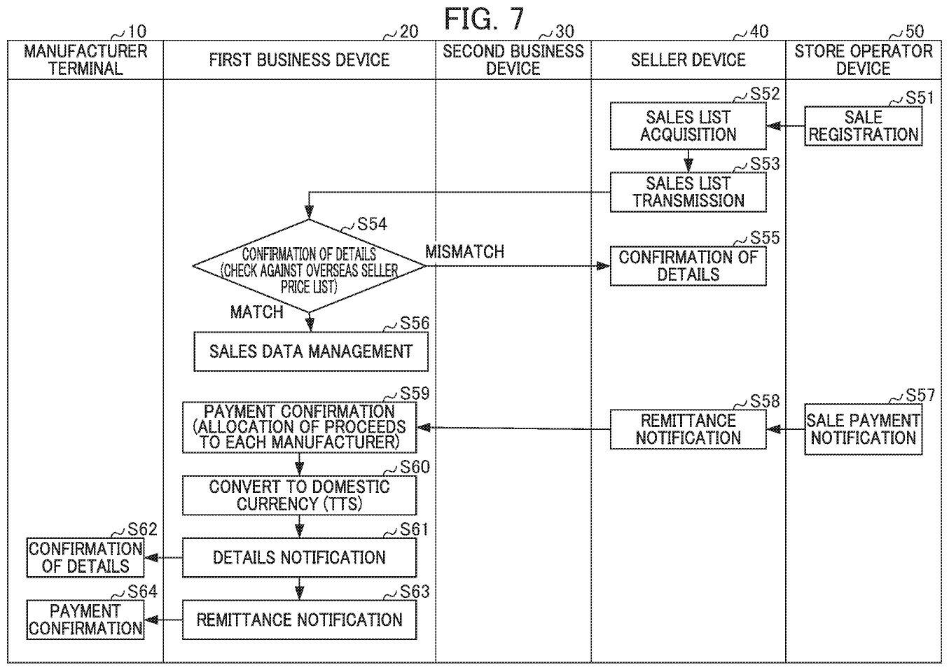

Operations for a proceeds adjustment according to the present embodiment will be described next with reference to the flowchart in FIG. 7. In step S51, the store operator device 50 transmits, to the seller device 40, a sales register for products that have been sold through sales. This transmission is performed on the basis of an operation by a store operator who has confirmed the sale. Note that, in the case of e-commerce transactions, the sales register may be issued automatically by the store operator device 50, for example.

In step S52, the seller device 40 acquires a sales list which is a list of sales that have been registered thus far. The sales list may be updated by the seller device 40 whenever a sale is registered or may be acquired from the store operator device 50.

In step S53, the seller device 40 transmits the sales list to the first business terminal 20. The sales list contains sales codes that correspond to the products sold.

In step S54, by referring to the management information stored in the management information storage unit 22 on the basis of the sales codes contained in the sales list received from the seller device 40, the first business terminal 20 rapidly and reliably specifies the information of the products that correspond to the sales codes. Furthermore, by calculating sales on the basis of the product information and a store operator price list and checking these sales against the sales claimed by means of the sales list, the first business terminal 20 decides whether or not the sales according to the sales list are correct.

When both sets of compared sales do not match (a mismatch in step S54), the first business terminal 20 makes a transmission to the seller device 40 to request confirmation of the details. The seller device 40 makes an output to the effect that the details must be confirmed. The output is made using a printing or display device or another such device so that the seller can be notified. On the other hand, if both sets of compared sales match (a match in step S54), the processing moves to step S56.

In step S56, the first business terminal 20 manages the sales in the sales list as data. For example, the first business terminal 20 implements management by updating the sales data in a management information table stored by the management information storage unit 22.

In step S57, the store operator device 50 transmits, to the seller device 40, a payment notification for the seller regarding sales obtained by selling products. This transmission is performed on the basis of an operation by a store operator who has confirmed payment for the sales.

In step S58, the seller device 40 transmits, to the seller device 40, a remittance notification for the administrator regarding sales obtained by selling products. This remittance notification contains the sales codes of the products corresponding to the remittance. This transmission is performed on the basis of an operation by a seller who has confirmed the sales, for example.

In step S59, the first business terminal 20 confirms that the remittance has been received. Specifically, by referring to the management information stored in the management information storage unit 22 on the basis of the sales code contained in the remittance notification received from the seller device 40, the first business terminal 20 rapidly and reliably specifies the manufacturer who is the recipient of the remittance and corresponds to the reception code linked with the sales code. Further, in this case, the proceeds are allocated to each manufacturer according to the quantity and so forth of products which have been sold. This payment confirmation is performed on the basis of an operation by the administrator who has confirmed the payment, for example.

In step S60, the first business terminal 20 converts the proceeds paid to the domestic currency. The conversion is made on the basis of TTS (Telegraphic Transfer Selling). Here, the remittance of proceeds from the seller device 40 is made in a foreign currency. In this case, the first business terminal 20 may be configured to convert the proceeds received in the foreign currency to the domestic currency of the administrator and to make the remittance to the manufacturer in the domestic currency. Thus, conversion by the seller may be unnecessary. Centralized management by the administrator including currency conversion is also possible. Moreover, the manufacturer may be able to make consignment fee payments and also receive proceeds in the domestic currency.

In step S61, the first business terminal 20 transmits details of the proceeds to the manufacturer terminal 10. In step S62, the manufacturer terminal 10 confirms the details of the proceeds. The confirmation result is output using a printing or display device so that the manufacturer who is the user can be notified.

In step S63, the first business terminal 20 transmits a proceeds remittance notification to the manufacturer terminal 10. In step S64, the manufacturer terminal 10 confirms payment of the proceeds. The confirmation result is output using a printing or display device so that the manufacturer who is the user can be notified.

The manufacturer who is the recipient of the proceeds details and proceeds remittance notification in steps S61 and S63 is the recipient manufacturer that corresponds to the reception code linked with the sales code and who was specified in the processing of step S59. Furthermore, the reception codes of the products sold may be included in the proceeds details and proceeds remittance notification in order to indicate which products the proceeds are from. As a result of the processing described hereinabove with reference to FIG. 7, it is possible to perform an adjustment of the proceeds.

The present embodiment described hereinabove affords many advantageous effects, as will be described hereinbelow. For example, the present embodiment affords the effect of enabling management to be implemented in a more expedient manner than heretofore in a commercial transaction involving an export. This is because, by associating two management information items, namely, reception codes and sales codes, sales-related processing which is generated domestically and overseas can be centrally managed.

Moreover, the processing from the second sale onwards by a manufacturer is smoother, which affords the effect of increased manufacturer convenience. This is because import/export feasibility and salability are decided in the initial sale processing, but from the second sale onwards this decision can be dispensed with.

This also affords the effect of obviating the need to perform export processing individually for each manufacturer. This is because even when the owners of export products are different, the products can be exported as a single consolidated shipment of products by means of the processing according to the present embodiment.

In addition, because the products can be exported as a single consolidated shipment of products, transport costs can be reduced and the customs process can also be alleviated, which also affords the effect of permitting low cost exports overall.

Furthermore, because the products can be exported as a single consolidated shipment of products, the manufacturer only needs to add the reported sales codes as shipping marks or the like, and does not need to implement subsequent management overseas.

Moreover, in the present embodiment, from the perspective of the store operator, the sales codes, which are management information the store operator uses, can be used as is, whereby unnecessary labor can be spared. Furthermore, from the perspective of the seller, it is possible to spare the labor of expressly indexing original management numbers.

Note that each of the terminals and devices included in the foregoing sales management system can be realized by means of hardware, software or a combination or hardware and software. In addition, the sales management method performed by each of the terminals and devices included in the sales management system can be realized by means of hardware, software or a combination or hardware and software. Here, realized by software means realized as a result of a computer reading and executing a program.

Programs can be stored using various types of non-transitory computer-readable media and supplied to the computer. Non-transitory computer-readable media include tangible storage media of various types of entity. Examples of non-transitory computer-readable media include magnetic recording media (flexible disks, magnetic tapes, hard disk drives, for example), magneto-optical recording media (magneto-optical disks, for example), CD-ROMs (Read Only Memory), CD-R, CD-R/W, semiconductor memory (mask ROM, PROM (Programmable ROM), EPROM (Erasable PROM), flash ROM, and RAM (random access memory), for example). Programs may also be supplied to a computer by means of various types of transitory computer-readable media. Examples of transitory computer-readable media include electrical signals, optical signals and electromagnetic waves. Transitory computer-readable media enable programs to be supplied to a computer via a wired communication channel such as wires and optical fibers, or a wireless communication channel.

Furthermore, the foregoing embodiment is a preferred embodiment of the present invention, but the scope of the present invention is not limited to the foregoing embodiment, rather, the present invention can be carried out using various modified modes within the scope and not departing from the spirit of the present invention.

For example, although a business desiring sales of a product overseas is called a manufacturer in the foregoing description, the business need not be a manufacturer and could also be a business wishing to procure stock and make sales overseas.

In addition, although a distinction has been made between the roles of manufacturer, administrator, seller and store operator in the foregoing description, one role may be fulfilled through cooperation between a plurality of businesses. Moreover, one business may also fulfill a plurality of roles. There may also be a plurality of businesses fulfilling the same role. That is, the process until the sale of a product described with reference to FIG. 1 is merely an example and does not limit the scope of application of the present embodiment. Furthermore, in this regard, there may also be a plurality of devices in a case where one role is fulfilled through cooperation between a plurality of businesses or in a case where a plurality of businesses fulfill the same role. For example, there may be a plurality of the seller device 40 like the number of manufacturer terminals 10 when the role of seller is fulfilled through cooperation between a plurality of businesses or in a case where there are a plurality of businesses fulfilling the role of seller. Likewise, there may be a plurality of the store operator device 50 like the number of manufacturer terminals 10 when the role of store operator is fulfilled through cooperation between a plurality of businesses or in a case where there are a plurality of businesses fulfilling the role of store operator.

Furthermore, the foregoing series of processes in steps S11 to S64 are an example of suitable processes of the present embodiment and do not limit the processing method of the present embodiment. For example, the foregoing description of steps S51 and S57 describes the proceeds being registered and a proceeds payment notification being issued spontaneously by the store operator device 50 when a product has been sold. However, depending on the store operator, a case where such spontaneous processing by means of the store operator device 50 is not performed may also be assumed. In such a case, the seller device 40 may issue an inquiry to the store operator device 50 at regular intervals to acquire notification of proceeds registration or proceeds payment. In other words, a portion of the foregoing series of processes in steps S11 to S64 can be suitably modified according to the situation in which the present embodiment is applied.

### EXPLANATION OF REFERENCE NUMERALS

10 Manufacturer terminal
20 First business terminal
21 Management unit
22 Management information storage unit
23 Domestic communication unit
30 Second business terminal
31 Export management unit
32 Export information storage unit
33 Communication unit
40 Overseas business device
50 Overseas seller device

1. A sales management system which, on receiving a request for a salability decision from a first country for each product which has been assigned first management information, decides a salability for a second country, responds with second management information for salable products to a requestor in the first country, stores, for each of the products, the first management information and second management information in linkage with each other, and, on the basis of the linked first management information and second management information, implements management relating to a sale of the products in the second country, involving an import, from the first country to the second country, of a single consolidated shipment of the products, which are sold by different manufacturers and have different owners, one administrator serving as consignor and one seller serving as consignee during customs clearance.

2. A sales management system, comprising:
domestic communication means which receives a product sales request from a manufacturer terminal;
management means which, On receiving the product sales request, assigns first management information to each of the products;
overseas communication means which issues a request for a salability decision for the products to an overseas business device and receives, in response, second management information assigned to salable products; and
management information storage means which stores, for each of the products, the first management information and second management information in linkage with each other,
wherein, on the basis of the linked first management information and second management information, the management means implements management relating to a sale of the products overseas, involving an export overseas from a domestic country of a single consolidated shipment of the products, which are sold by different manufacturers and have different owners, one administrator serving as consignor and one seller serving as consignee during customs clearance.

3. The sales management system according to claim wherein the management means generates and outputs export information for the export, on the basis of the linked first management information and second management information.

4. The sales management system according to claim 2, wherein the domestic communication means transmits the second management information to the manufacturer terminal as product management information which is assigned directly or indirectly to product stock when the products are shipped by the manufacturer.

5. (canceled)

6. The sales management system according to claim 2, wherein the management means
specifies, using the linked first management information, a payment source in payment management of deposit fees for overseas sales of the products which are paid by the manufacturer,
specifies, using the linked first management information, a payout destination in payout management of a payment of either transportation costs or management costs, or both, for a domestic business, which is paid from the deposit fees, and
specifies, using the linked second management information, a payout destination in payout management of a payment of either transportation costs or management costs, or both, for an overseas business, which is paid from the deposit fees.

7. The sales management system according to claim 2, wherein the management means
specifies, using the linked second management information, a payment source in payment management of proceeds of the products when the products have been sold overseas, and
specifies, using the linked first management information, a remittance destination in payout management of a remittance of the proceeds to the manufacturer.

8. The sales management system according to claim 7, wherein the management means manages payment in a foreign currency of the product proceeds, and by converting an amount of money of the product proceeds to a domestic currency, manages payout of the remittance to the manufacturer in the domestic currency.

9. A sales management method implemented by a computer, comprising:
a step of, on receiving a request for a salability decision from a first country for each product which has been assigned first management information, deciding a salability for a second country, responding with second management information for salable products to a requestor in the first country; and
a step of storing the first management information and second management information in linkage with each other,
wherein, on the basis of the linked first management information and second management information, management relating to a sale of the products in the second country, involving an import, from the first country to the second country, of a single consolidated shipment of the products, which are sold by different manufacturers and have different owners, one administrator serving as consignor and one seller serving as consignee during customs clearance, is implemented.

10. A sales management method implemented by a computer, comprising:
a domestic communication step of receiving a product sales request from a manufacturer terminal;
a management step of, on receiving the product sales request, assigning first management information to each of the products;
an overseas communication step of issuing a request for a salability decision for the products to an overseas business device and receiving, in response, second management information assigned to salable products; and
a management information storage step of storing, for each of the products, the first management information and second management information in linkage with each other,
wherein, on the basis of the linked first management information and second management information, management relating to a sale of the products overseas, involving an export overseas from a domestic country of a single consolidated shipment of the products, which are sold by different manufacturers and have different owners, one administrator serving as consignor and one seller serving as consignee during customs clearance, is implemented.

11. The sales management system according to claim 3, wherein the management means generates the export information before deposit fees for overseas sales of the produces have been received from the manufacturer, and outputs the export information for the export in response to the deposit fees for overseas sales of the products being received from the manufacturer.
